(19) United States
(12) Patent Application Publication
(10) Pub. No.: US 2016/0182312 A1
(43) Pub. Date: Jun. 23, 2016

(54) Location-based, Server Assisted Peer to Peer Service with Extensible Service Categories

(71) Applicant: Futurewei Technologies, Inc., Plano, TX (US)

(72) Inventors: Yumin Tang, San Diego, CA (US); Julia Wang, San Diego, CA (US); April Trost, San Diego, CA (US); Limei Wang, San Diego, CA (US)

(21) Appl. No.: 14/573,896

(22) Filed: Dec. 17, 2014

(51) Int. Cl. H04L 12/24; G06Q 30/06; G06Q 30/02; H04L 29/08

(52) U.S. Cl. CPC H04L 41/5006; H04L 67/1087; G06Q 30/0609; G06Q 30/0277

(57) ABSTRACT

Peer-to-peer service agreements can be facilitated by a third party without the terms of the service agreement being brokered by the third-party. In one example, a user sends a service request to a network node maintained by the third-party. The third-party operator identifies candidate service providers registered to provide the requested service, and sends referrals to the identified candidates. The referrals may be sent to each candidate device without filtering the candidate devices based on their real-time locations. The referrals may prompt a service agreement to be independently established between operators of the requesting device and one of the candidate devices without brokering from the third-party.

### TECHNICAL FIELD

The present invention relates to the field of wireless communications, and, in particular embodiments, to a system and method for location-based peer-to-peer service and architecture.

### BACKGROUND

Networking applications and protocols supporting peer-to-peer services have recently expanded to wireless communication systems. For example, new applications and social networking services (SNS) such as Facebook and Twitter are being implemented and embedded in wireless devices such that subscribers can access services on-demand regardless of their physical location. Moreover, third-party mobile applications have begun to broker peer-to-peer service agreements. For example, Uber has developed mobile applications that broker ride-sharing agreements between passengers and drivers. More specifically, the passenger uses an Uber application on their mobile device to send a ride-request to a network server operated by (or on behalf of) Uber. Upon receiving the ride-request, the network server distributes a fare offer to candidate drivers based on their real-time locations, and brokers a ride-sharing agreement between the passenger and a selected one of the candidate drivers (e.g., typically the first to respond). Notably, these third-party operators typically “broker” the service agreement by defining its terms, as well as by selected one or both of the parties. For example, Uber brokers its ride-share agreement by defining the terms of agreement (e.g., the rate or fair), as well as by selecting the candidate driver. Moreover, many third-party operators are beneficiaries to the service agreements, e.g., Uber is entitled to a percentage of the fair.

### SUMMARY OF THE INVENTION

Technical advantages are generally achieved, by embodiments of this disclosure which describe location-based, server assisted peer-to-peer service with extensible service categories.

In accordance with an embodiment, a method for facilitating peer-to-peer (P2P) service agreements is provided. In this example, the method comprises receiving a request for a service from a requesting device, identifying candidate devices registered to provide the service, and distributing referrals to each of the candidate devices. The referrals prompt a service agreement to be independently established between operators of the requesting device and a first one of the candidate devices without brokering of the service agreement by an operator of the network node. An apparatus for performing this method is also provided.

In accordance with another embodiment, a method for establishing a peer-to-peer (P2P) service agreement is provided. In this example, the method comprises registering a candidate device as a service provider with an operator of a network node, receiving a referral from the network node indicating that a service has been requested by a requesting device, and determining whether to ignore or respond to the referral. The method further includes sending an offer to provide the service to the requesting device upon determining to respond to the referral, and independently establishing a service agreement between operators of the candidate device and the requesting device without brokering of the service agreement from an operator of the network node when the offer is accepted by the requesting device. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless network;

FIG. 2 illustrates a diagram of an embodiment network architecture for facilitating the establishment of peer-to-peer service agreements;

FIG. 3 illustrates a diagram of a conventional architecture for brokering peer-to-peer service agreements;

FIG. 4 illustrates a diagram of an embodiment architecture for facilitating peer-to-peer service agreements;

FIG. 5 illustrates a flowchart of an embodiment method for facilitating peer-to-peer service agreements;

FIG. 6 illustrate a diagram of an embodiment method for establishing peer-to-peer service agreements;

FIG. 7 illustrates a diagram of an embodiment communications device; and

FIG. 8 illustrates a diagram of an embodiment computing platform.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Oftentimes, brokered peer-to-peer service agreements offer convenience and simplicity for both parties. However, in some situations, brokering constrains, or otherwise limits, the ability of parties to negotiate and/or reach an agreement. Brokering may also benefit the third-party operator at the expense of the providers and recipients. Accordingly, alternative techniques for facilitating flexible peer-to-peer agreements absent third-party intervention are desired.

Aspects of this disclosure provide techniques for facilitating peer-to-peer service agreements without brokering the terms of the service agreement by a third-party. In one example, a user sends a service request to a network node maintained by a third-party operator. The third-party operator identifies candidate service providers registered to provide the requested service, and sends referrals to the identified candidates. In some embodiments, the referrals are sent to each candidate device registered to provide the service without filtering the candidate devices based on their real-time locations. For example, a service request received from a requesting device in a large city may be distributed to all candidate devices registered to provide the service in the city irrespective of whether the candidate devices are located near-by the requesting device. In such embodiments, location-based filtering may be autonomously performed by the candidate devices. For example, the referrals may indicate a location of the requesting device, and the candidate devices may autonomously ignore referrals from requesting devices located more than a threshold distance from the respective candidate device. Referrals received from requesting devices within the threshold distance may be presented to an operator of the candidate device, who may decide to respond to or ignore the referral. For example, an operator presented with a referral may elect to submit an offer to provide the service to the requesting party. If the offer is accepted, then a service agreement is independently established between operators of the requesting device and the candidate device without brokering from a third-party. These and other aspects are explained in greater detail below.

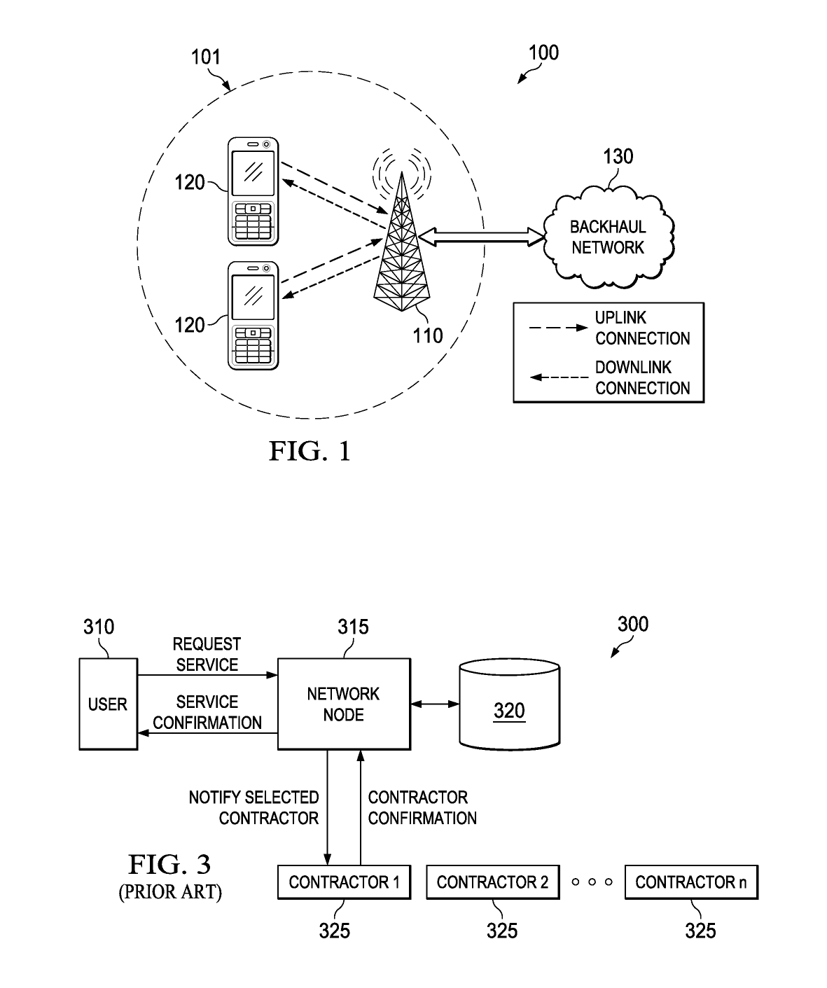

Aspects of this disclosure may be implemented in wireless networks. FIG. 1 illustrates a network 100 for communicating data. The network 100 comprises an access point (AP) 110 having a coverage area 101, a plurality of mobile devices 120, and a backhaul network 130. The AP 110 may comprise any component capable of providing wireless access by, inter alia, establishing uplink (dashed line) and/or downlink (dotted line) connections with the mobile devices 120, such as a base station, an enhanced base station (eNB), a femtocell, and other wirelessly enabled devices. The mobile devices 120 may comprise any component capable of establishing a wireless connection with the AP 110, such as user equipment (UE), a mobile station (STA), or other wirelessly enabled devices. The backhaul network 130 may be any component or collection of components that allow data to be exchanged between the AP 110 and a remote end (not shown). In some embodiments, the network 100 may comprise various other wireless devices, such as relays, low power nodes, etc.

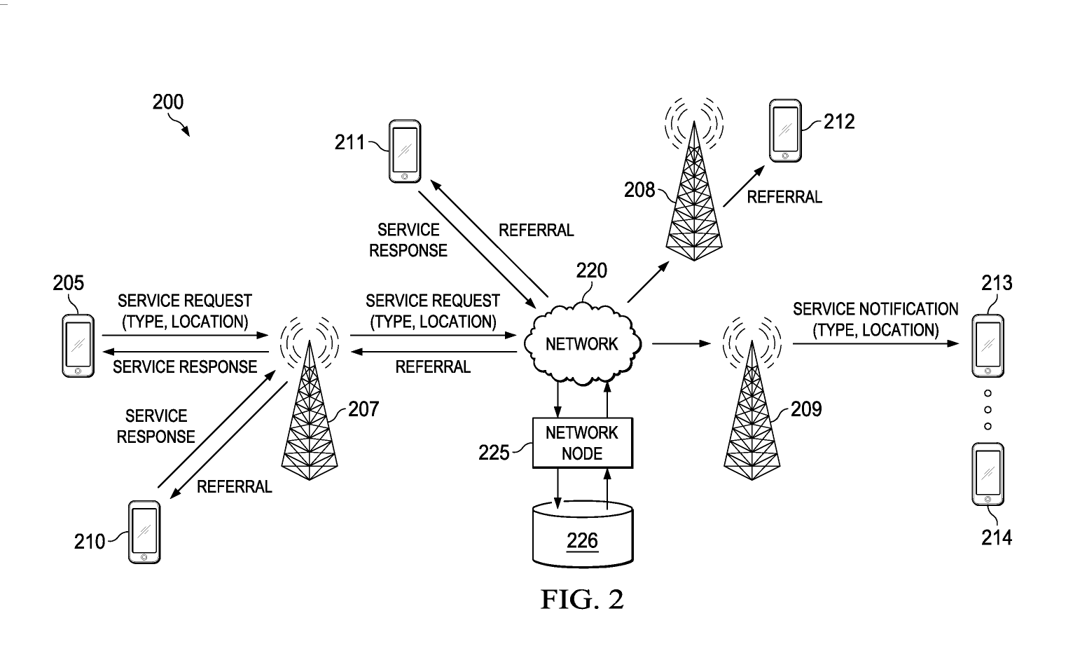

Aspects of this disclosure provide techniques for facilitating peer-to-peer service agreements. FIG. 2 illustrates an embodiment network architecture 200 for facilitating the establishment of peer-to-peer service agreements between peer devices. As shown, the embodiment network architecture 200 comprises a requesting mobile device 205, a plurality of candidate devices 210-213, a registered device 214, a plurality of radio access networks (RANs) 207, 208, 209, a network 220, a network node 225, and a storage location 226. The network node 225 may be a server operated by a third-party for the purpose of facilitating peer-to-peer service agreements, and the storage location 226 may be a data base storing information for facilitate the peer-to-peer service agreements. In this example, the storage device 226 stores a list of registered devices (e.g., the candidate devices 210-214) registered to provide services. The candidate devices 210-214 may pre-register with the third-party operator to provide the service.

As shown, the requesting mobile device 205 sends a service request to the network node 225 via the RAN 207 and the network 220. The service request may indicate a service category (e.g., a type of service) and/or location information of the requesting mobile device 205. The location information of the requesting mobile device 205 may be obtained from a positioning system, such as a global positioning system (GPS) or a local positioning system (e.g., WiFi based positioning etc.). Alternatively, the location information may indicate a network location or access point, e.g., an identifier associated with the RAN 207, etc.

When the network node 225 receives the service request from the requesting mobile device 205, the network node 225 identifies candidate service providers registered to provide the requested service using the information stored at the storage location 226. In this example, the candidate devices 210-213 are registered to provide the requested service. The registered device 214 is not registered to provide the requested service, but instead is registered to provide another type of service. Accordingly, the network node 225 identifies the candidate devices 210-213 as candidates for providing the requested service, and proceeds to send referrals to the candidate devices 210-213.

The referrals may include the service category and location information indicated by the service request. In some embodiments, the referrals may be sent to the candidate devices 210-213 without filtering the candidate devices 210-213 based on their real time locations. As shown, the candidate devices 210, 212, 213 are mobile devices connected to radio access networks, while the candidate device 211 is some other type of device, e.g., a stationary device (e.g., PC, etc.), a mobile device connected to a private WLAN, etc. In this example, the candidate devices 210-212 are located in relatively close proximity to the requesting mobile device 205, while the candidate device 213 is located further away from the requesting mobile device 205. Nevertheless, the network node 225 sends the referrals to each of the candidate devices 210-213 irrespective of their relative location to the requesting mobile device 205. In some embodiments, the network node 225 does not track the real-time locations of the candidate devices 210-213.

In some embodiments, filtering may be autonomously performed by the candidate devices 210-213 upon receiving the referrals. In this example, the candidate device 213 may autonomously ignore the referral because the requesting mobile device 205 is located more than a threshold distance from the candidate device 213. There may be other reasons for autonomously ignoring the referral, e.g., the candidate device 213 is turned off, the candidate device 213 is configured to ignore referrals outside a pre-defined time-window, etc.

The candidate devices 210-212 may determine not to autonomously ignore the referrals, and may instead prompt their respective operators to respond to ignore the referrals. For example, the candidate devices 210-212 may prompt their operators to affirmatively ignore or respond to the referral using a graphical user interface, e.g., a touchscreen, keyboard, etc. In this example, the operator of the candidate device 212 elects to ignore the referral, while the operators of the candidate devices 210, 211 elect to respond to the referral with an offer to provide the request service. In some embodiments, the responses are sent directly from the candidate devices 210, 211 to the requesting mobile device 205 without being relayed through the network node. In other embodiments, the responses are relayed through the network node. The responses may include various information relating to the offer. For example, the responses may propose a general location (e.g., ZIP code) to provide the service, a time and/or day to provide the service, conditions of the service (e.g., fair, rate, performance criteria, etc.), contact information for the offering party(e.g., a phone number of the devices 210, 211, an email address, etc.), or combinations thereof. Upon receiving the responses, the operator of the requesting mobile device 205 may negotiate a service agreement with of the candidate devices 210, 211. This may be performed without brokering or intervention from the third-party operator of the network node 225.

Prior art techniques for brokering peer-to-peer service agreements may constrain, or otherwise limit, the ability of the parties to negotiate and/or establish terms of the service agreement. FIG. 3 illustrates a conventional architecture 300 for brokering peer-to-peer service agreements. As shown, the conventional architecture 300 comprises a user 310, a network node 315, a central server 320, and contractors 325. The contractors 325 register with the network node 315 to provide a service, and the registration information is stored in the central server 320. The user 310 sends a service request to the network node 315, and the network node 315 brokers a service agreement between the user 310 and one of the contractors 325. More specifically, the network node 315 selects which of the contractors 325 will provide the service to the user 310, defines the terms of the service agreement, and then confirms the service agreement with the selected contractor 325 and user 310. For example, the network node 315 may filter the contractors 325 based on their real-time locations (e.g., proximity to the user 310, etc.) or some other criteria, and then present the remaining subset of contractors with the opportunity to fulfill the service request under pre-defined terms (e.g., cost etc.). The network node 315 may then arrange for one of the responding contractors (e.g., the first to respond, etc.) to fulfill the service request in accordance with the brokered service agreement. Brokered peer-to-peer service agreements may constrain a freedom of negotiation of terms between peer-to-peer operators in order to finalize the agreement because the negotiation induces undesirable delay and overhead signaling. In one aspect, there may be a privacy issue with a tracking of real-time location information because the real-time location information may be reported to the broker without user awareness.

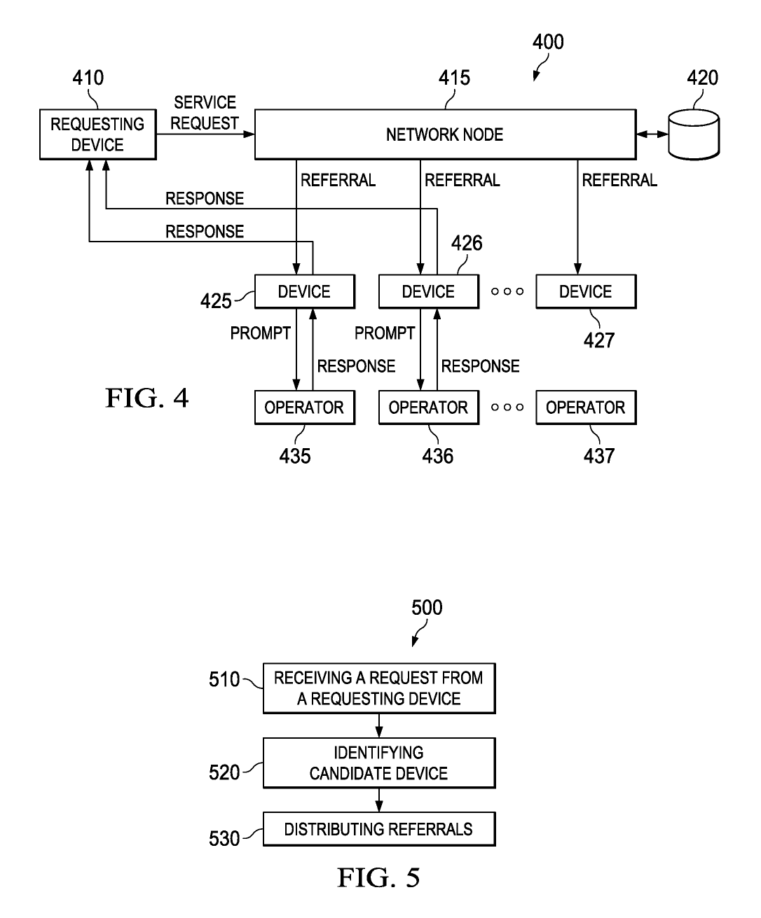

Aspects of this disclosure facilitate the establishment of peer-to-peer service agreements without brokering by third-party operators. FIG. 4 illustrates an embodiment architecture 400 for facilitating the establishment of peer-to-peer service agreements. As shown, the embodiment architecture 400 comprises a requesting device 410, a network node 415, a storage location 420, a plurality of candidate devices 425-427, and a plurality of operators 435-437 of the candidate devices 425-427. In this example, the candidate devices 425 are registered with the network node 415 to provide a service, and the requesting device 410 sends a service request to the network node 415 requesting the service. The network node 415 sends referrals to the candidate devices 425-427. The candidate device 427 autonomously ignores the referral, while the candidate devices 425, 426 prompt the operators 435, 436 to respond to the referral. The operators 435, 436 respond to the referral, and the responses are forwarded to the requesting device 410, which establishes a peer-to-peer service agreement with at least one of the operators 435, 436.

Aspects of this disclosure provide methods for facilitating peer-to-peer service agreements. FIG. 5 illustrates an embodiment method 500 for facilitating establishment of a peer-to-peer service agreement, as may be performed by a network node operated by a third-party. As shown, the method 500 begins at step 510, where the network node receives a request for a service from a requesting device. Next, the method 500 proceeds to step 520, where the network node identifies one or more candidate device registered to provide the requested service. Finally, the method 500 proceeds to step 530, where the network node distributes referrals to the candidate devices. The referrals prompt a service agreement to be independently established between operators of the requesting device and the candidate device without brokering of the service agreement by the operator of the network node.

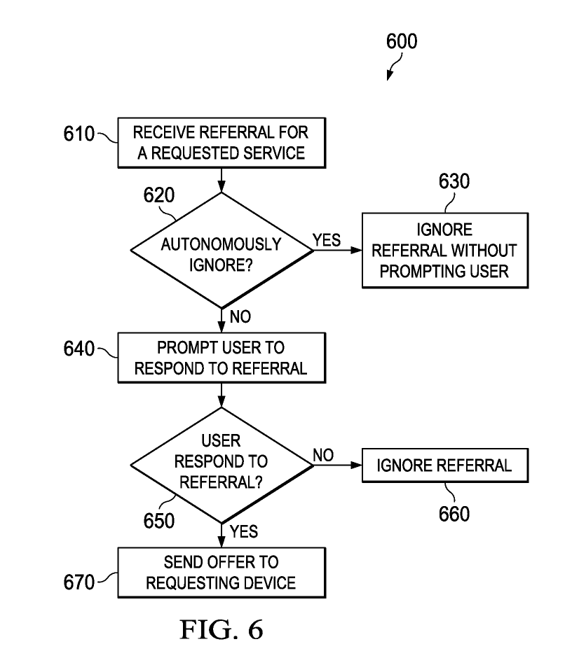

Aspects of this disclosure also provide methods for establishing peer-to-peer service agreements. FIG. 6 illustrates an embodiment method 600 for establishing a peer-to-peer service agreement, as may be performed by a candidate device that is registered to provide a service. As shown, the method 600 begins at step 610, where the candidate device receives a referral from a network node. The referral indicates that a service has been requested by a requesting device. Subsequently, the method 600 proceeds to step 620, where the candidate device determines whether to autonomously ignore the referral. In some embodiments, the candidate device may autonomously ignore the referral when a criteria is satisfied (e.g., proximity of candidate device to requesting device exceeds threshold, etc.). If the candidate device decides to autonomously ignore the referral, then the method 600 proceeds to step 630, where the candidate device ignores the referral without prompting the user, e.g., without notifying the operator of the service request.

Alternatively, if the candidate device decides not to autonomously ignore the referral, then the method 600 proceeds to step 640, where the candidate device prompts the user to respond to the referral. Subsequently, the method 600 proceeds to step 650, where the candidate device determines whether the user responded to the referral. If not, then the candidate device ignores the referral at step 660. Otherwise, if the user responds to the referral, then the method 600 proceeds to step 670, where the candidate device sends an offer to provide the service to the requesting device. The offer may prompt negotiation and/or establishment of a service agreement between the candidate device and the requesting device.

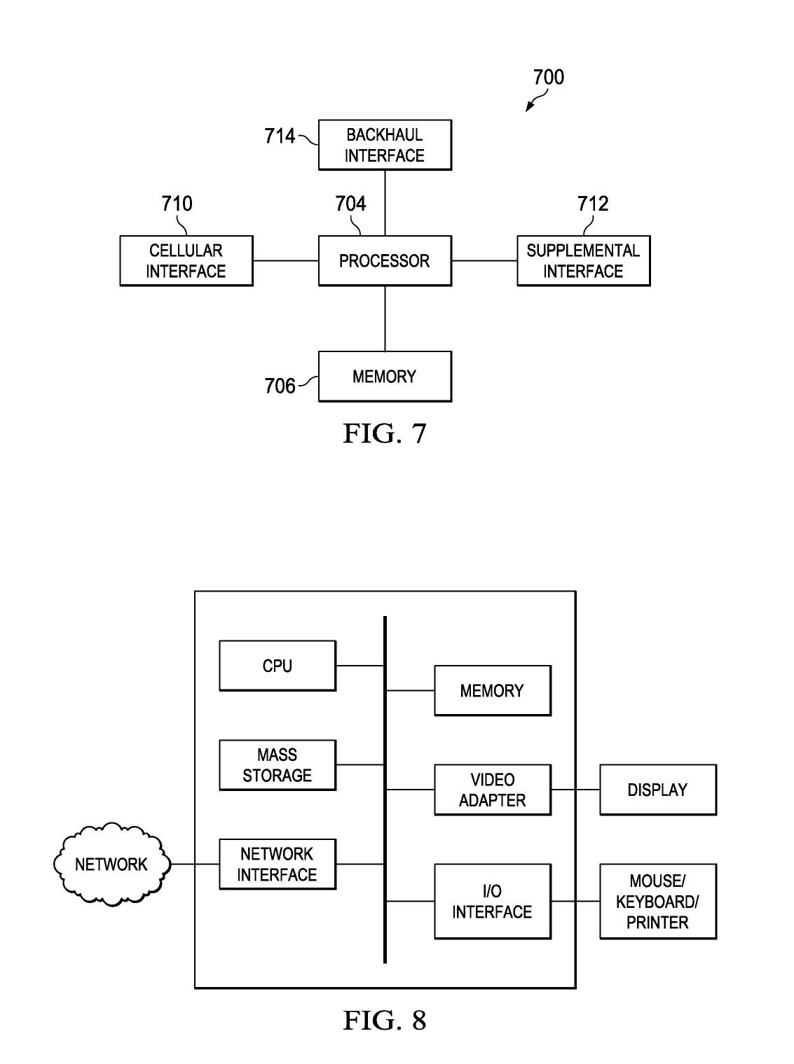

FIG. 7 illustrates a block diagram of an embodiment of a communications device 700, which may be equivalent to one or more devices (e.g., requesting devices, candidate devices, network nodes, etc.) discussed above. The communications device 700 may include a processor 704, a memory 706, a cellular interface 710, a supplemental interface 712, and a backhaul interface 714, which may (or may not) be arranged as shown in FIG. 7. The processor 704 may be any component capable of performing computations and/or other processing related tasks, and the memory 706 may be any component capable of storing programming and/or instructions for the processor 704. The cellular interface 710 may be any component or collection of components that allows the communications device 700 to communicate using a cellular signal, and may be used to receive and/or transmit information over a cellular connection of a cellular network. The supplemental interface 712 may be any component or collection of components that allows the communications device 700 to communicate data or control information via a supplemental protocol. For instance, the supplemental interface 712 may be a non-cellular wireless interface for communicating in accordance with a Wireless-Fidelity (Wi-Fi) or Bluetooth protocol. Alternatively, the supplemental interface 712 may be a wireline interface. The backhaul interface 714 may be optionally included in the communications device 700, and may comprise any component or collection of components that allows the communications device 700 to communicate with another device via a backhaul network.

FIG. 8 is a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of non-transitory system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of non-transitory storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for facilitating peer-to-peer (P2P) service agreements, the method comprising:
receiving, by a network node, a request for a service from a requesting device;
identifying, by the network node, candidate devices registered to provide the service; and
distributing referrals to each of the candidate devices, wherein the referrals prompt a service agreement to be independently established between operators of the requesting device and at least a first one of the candidate devices without brokering of the service agreement by an operator of the network node.

2. The method of claim 1, wherein terms of the service agreement establish a performance obligation between operators of the first candidate device and the requesting device.

3. The method of claim 1, wherein distributing referrals to each of the candidate devices comprises:
multicasting the referrals to each of the candidate devices without filtering the candidate devices based on real-time locations of the candidate devices.

4. The method of claim 3, wherein real-time locations of the candidate devices are not available to the operator of the network node prior to distributing the referrals to the candidate devices.

5. The method of claim 1, wherein the referrals indicate a location of the requesting device and the service being requested.

6. The method of claim 5, wherein the location of the requesting device is provided by a positioning system.

7. The method of claim 5, wherein distributing one of the referrals to the first candidate device prompts the first candidate device to send an offer for service to the requesting device directly without the offer for service being relayed through the network node.

8. The method of claim 7, wherein the requesting device and the candidate device are mobile devices connected to radio access networks.

9. The method of claim 8, wherein the network node is an application server in a remote network adapted to communicate with the radio access networks via a backhaul network, and wherein the offer is relayed through the radio access networks without being communicated to the remote network.

10. A network node comprising:
a processor; and
a computer readable storage medium storing programming for execution by the processor, the programming including instructions to:
receive a request for a service from a requesting device;
identify candidate devices registered to provide the service; and
distribute referrals to each of the candidate devices, wherein the referrals prompt a service agreement to be independently established between operators of the requesting device and at least a first one of the candidate devices without brokering of the service agreement by an operator of the network node.

11. The network node of claim 10, wherein terms of the service agreement establish a performance obligation between operators of the candidate device and the requesting device.

12. The network node of claim 10, wherein distributing referrals to each of the candidate devices comprises:
multicasting the referrals to each of the candidate devices without filtering the candidate devices based on real-time locations of the candidate devices.

13. A method for establishing a peer-to-peer (P2P) service agreement, the method comprising:
registering a candidate device as a service provider with an operator of a network node;
receiving, by the candidate device, a referral from the network node, the referral indicating that a service has been requested by a requesting device;
determining whether to ignore or respond to the referral;
sending, by the candidate device, an offer to provide the service to the requesting device upon determining to respond to the referral; and
independently establishing a service agreement between operators of the candidate device and the requesting device without brokering of the service agreement from an operator of the network node when the offer is accepted by the requesting device.

14. The method of claim 13, wherein determining whether to ignore or respond to the referral comprises:
autonomously filtering the referral to determine whether the referral satisfies a criteria; and
prompting the operator of the candidate device to either ignore or respond to the referral when the referral satisfies the criteria.

15. The method of claim 14, wherein autonomously filtering the referral to determine whether the referral satisfies the criterion comprises:
calculating a distance between the candidate device and the requesting device in accordance with location information specified by the referral; and
autonomously ignoring the referral when the distance between the candidate device and the requesting device exceeds a threshold.

16. The method of claim 14, wherein the operator of the candidate device is prompted to either ignore or respond to the referral when a distance between the candidate device and the requesting device does not exceed a threshold.

17. The method of claim 13, wherein terms of the service agreement establish a performance obligation between operators of the candidate device and the requesting device.

18. The method of claim 17, wherein independently establishing the service agreement with the operator of the requesting device comprises:
negotiating, by the candidate device, the terms of the service agreement with the requesting device without notifying the operator of the network node about the terms of the service agreement.

19. The method of claim 13, wherein sending the offer to provide the service to the requesting device upon determining to respond to the referral comprises:
sending the offer directly to the requesting device without notifying the operator of the network node of the offer.

20. A candidate device comprising:
a processor; and
a computer readable storage medium storing programming for execution by the processor, the programming including instructions to:
register a candidate device as a service provider with an operator of a network node;
receive a referral from the network node, the referral indicating that a service has been requested by a requesting device;
determine whether to ignore or respond to the referral;
send an offer to provide the service from the candidate device to the requesting device upon determining to respond to the referral; and
independently establish a service agreement between operators of the candidate device and the requesting device without brokering of the service agreement from an operator of the network node when the offer is accepted by the requesting device.
